(19) United States
(12) Patent Application Publication
(10) Pub. No.: US 2021/0046549 A1
(43) Pub. Date: Feb. 18, 2021

(54) SOFT MAGNETIC POWDER, METHOD FOR PRODUCING Fe POWDER OR Fe-CONTAINING ALLOY POWDER, SOFT MAGNETIC MATERIAL, AND METHOD FOR PRODUCING POWDER MAGNETIC CORE

(71) Applicant: DOWA ELECTRONICS MATERIALS CO., LTD., Tokyo (JP)

(72) Inventors: Masahiro YOSHIDA, Tokyo (JP); Yoshiyuki MICHIAKI, Tokyo (JP); Kenichi INOUE, Tokyo (JP)

(73) Assignee: DOWA ELECTRONICS MATERIALS CO., LTD., Tokyo (JP)

(21) Appl. No.: 16/644,245

(22) PCT Filed: Sep. 3, 2018
(86) PCT No.: PCT/JP2018/032625

§ 371 Date: Mar. 4, 2020

(30) Foreign Application Priority Data
Sep. 4, 2017 (JP) 2017-169544
Jan. 30, 2018 (JP) 2018-013786

(51) Int. Cl. B22F 9/08

(52) U.S. Cl. CPC B22F 9/082; B22F 2301/35; B22F 2201/20; B22F 2009/0828

(57) ABSTRACT

Provided is a soft magnetic powder capable of forming a powder magnetic core having a high magnetic permeability with a decreased oxygen content even when the particle size is small. There is provided a soft magnetic powder including Fe alloy containing Si which is a soft magnetic powder containing 0.1% to 15 mass % of Si, and having a product of D50 multiplied by [O] (D50×[O]) being 3.0 [μm·mass %] or less, wherein D50 represents a volume-based cumulative 50% particle size [μm] of the soft magnetic powder as measured by a laser diffraction particle size distribution analyzer, and [O] represents an oxygen content [mass %].

### TECHNICAL FIELD

The present invention relates to a soft magnetic powder, a method for producing a Fe powder or a Fe-containing alloy powder, a soft magnetic material, and a method for producing a powder magnetic core.

### DESCRIPTION OF RELATED ART

An electronic device is equipped with a magnetic component having a powder magnetic core, such as an inductor. An electronic device applicable to higher frequency has been sought in order to attain higher performance and miniaturization. Concomitantly, a powder magnetic core, which configures the magnetic component, has also been requested to be applicable to higher frequency.

In general, the powder magnetic core is produced by compression molding, after soft magnetic powder is composited with a binding material such as a resin, if necessary. However, the powder magnetic core (soft magnetic powder) is likely to suffer from larger core loss (magnetic loss) on the higher frequency side. For this reason, it is desirable to use a soft magnetic powder having a small coercive force and a high magnetic permeability (hence a small hysteresis loss). Since a high magnetic permeability can be obtained, a FeSi alloy powder which contains Si has been proposed as the soft magnetic powder (see, for example, Patent Document 1). Patent Document 1 describes that the soft magnetic properties can be improved by compounding 5 mass % to 7 mass % of Si.

### PRIOR ART DOCUMENTS

### Patent Document

[Patent document 1] Japanese Unexamined Patent Publication No. 2016-171167

### SUMMARY OF THE INVENTION

### Problems to be Solved by the Invention

As described above, a high magnetic permeability is required for the powder magnetic core.

Incidentally, the core loss in the powder magnetic core increases as the frequency becomes higher. In particular, a loss caused by an eddy current (eddy current loss) induced by the magnetic field is proportional to the square of the frequency. Accordingly, the increase in the loss at higher frequency is remarkable. Therefore, in the powder magnetic core (particularly used in a high frequency region), it is conceivable to decrease the particle size of the soft magnetic powder used for forming the powder magnetic core, from the viewpoint of reducing the eddy current loss and controlling the core loss to low.

According to the investigation of the present inventors, however, it is found that when the particle size of the soft magnetic powder is decreased in order to reduce the eddy current loss of the powder magnetic core, an amount of oxygen increases and the magnetic permeability decreases (the hysteresis loss increases), so that the core loss cannot be sufficiently reduced.

In view of the foregoing, an object of the present invention is to provide a soft magnetic powder which has a decreased amount of oxygen even when the particle size is small, and can form a powder magnetic core having a high magnetic permeability, and to provide a related technology thereof.

### Means for Solving the Problem

Examples of a method conventionally used for producing a soft magnetic powder includes a water atomization method. In this method, a molten metal is prepared in a furnace, dripped from the nozzle of the furnace, pulverized and coagulated into a powder by spraying water thereon at a high pressure to obtain a slurry of the powder dispersed in that water. The slurry is subjected to liquid-solid separation and drying, providing a soft magnetic powder. The soft magnetic powder includes Fe (iron) as a main constituent element. Since iron is easily oxidizable, a slow oxidation is performed on the soft magnetic powder obtained after the drying for the purpose of preventing the oxidation. Specifically, the slow oxidation is a processing in which the particle surface of the powder is purposefully oxidized for the purpose of suppressing an excessive oxidation of the soft magnetic powder, to form a surface oxide film which functions as a protective film against the oxidation, for example, a processing in which a soft magnetic powder after the above-described drying, placed in a non-oxidizing atmosphere, is slowly oxidized while an oxygen concentration in its atmosphere is slowly increased.

According to the investigation of the present inventors, it is confirmed that when a soft magnetic powder is produced in such a process, the oxygen content in the powder is increased, and thereby the magnetic permeability is decreased.

Since the increase in the oxygen content is considered to be attributable not only to the slow oxidation but also to other causes, the present inventors have further investigated on the individual step. In the drying step of the conventional water atomization-based process for producing a soft magnetic powder, the drying is performed in a non-oxidizing atmosphere or under vacuum in order to prevent the oxidation of the soft magnetic powder, and at a high temperature of 100° C. or more in order to dry it quickly in view of productivity. The present inventors have found that performing this drying at a high temperature affects the high oxygen content of the soft magnetic powder produced through the subsequent steps such as the slow oxidation.

The mechanism is not clear but presumed as follows. In the soft magnetic powder after the solid-liquid separation step in the water atomization method, since it is exposed to the atmosphere during the preceding steps and in the course of transfer to the subsequent drying step, its surface is oxidized to a certain degree. When the soft magnetic powder is dried at a high temperature, it is considered that oxygen present on the particle surface (which is considered to be present as a surface oxide film for preventing further oxidation) is thermally diffused into the particle by heat. As a result, it is considered that the thickness of the oxide film which has been formed on the particle surface is decreased. It is considered that when the soft magnetic powder is subjected to the slow oxidation, the excessive oxidation occurs on the particle surface that has become easily oxidizable. According to this presumption, it is expected that the oxide film on the particle surface is retained and thus the excessive oxidation in the slow oxidation step can be prevented as long as oxygen does not thermally diffuse into the soft magnetic powder in the drying step.

In view of the foregoing, the present inventors decrease the drying temperature in the production of the soft magnetic powder. As a result, a soft magnetic powder with a decreased oxygen content compared to that of the conventional one can be obtained without performing the slow oxidation step. It is also found that when the product of D50 multiplied by [O] (D50×[O]) is 3.0 [μm·mass %] or less, wherein D50 represents a volume-based cumulative 50% particle size [μm] of the soft magnetic powder measured by a laser diffraction particle size distribution analyzer and [O] represents the oxygen content [mass %], a powder magnetic core having a high magnetic permeability can be formed even when the particle size of the soft magnetic powder is small.

Furthermore, since water having a predetermined strongly alkaline pH is used in the atomizing step in the water atomization method, a soft magnetic powder formable of a powder magnetic core having a high magnetic permeability, particularly with a decreased oxygen content can be produced.

In the soft magnetic powder provided by the present invention, the oxygen content can be suppressed low even when the particle size is decreased, and a high magnetic permeability can be achieved in the powder magnetic core.

As described above, the present inventors have completed the present invention.

According to a first aspect of the present invention,

there is provided a soft magnetic powder including Fe alloy containing Si,

the soft magnetic powder containing 0.1 mass % to 15 mass % of Si, and

a product of D50 multiplied by [O] (D50×[O]) being 3.0 [μm·mass %] or less, wherein D50 represents a cumulative 50% particle size [μm] of the soft magnetic powder as measured by a laser diffraction particle size distribution analyzer, and [O] represents an oxygen content [mass %].

A second aspect of the present invention is the soft magnetic powder of the first aspect,

wherein the D50 is 0.5 μm to 10 μm.

A third aspect of the present invention is the soft magnetic powder of the first or second aspect,

wherein the [O] is 0.75 mass % or less.

A fourth aspect of the present invention is the soft magnetic powder of the first to third aspects,

wherein the product of the D50 multiplied by the [O] (D50×[O]) is 0.5 [μm·mass %] to 2.6 [μm·mass %].

A fifth aspect of the present invention is the soft magnetic powder of the first to fourth aspects, including 84 mass % to 99.7 mass % of Fe.

A sixth aspect of the present invention is the soft magnetic powder of the first to fifth aspects,

including 2.0 mass % to 3.5 mass % of Si.

A seventh aspect of the present invention is the soft magnetic powder of the first to fifth aspects,

including 0.2 mass % to 0.5 mass % of Si.

An eighth aspect of the present invention is the soft magnetic powder of the first to seventh aspects,

wherein the [O] is 0.10 mass % to 0.60 mass %.

According to a ninth aspect of the present invention,

there is provided a method for producing a Fe powder or a Fe-containing alloy powder, including:

a molten metal preparation step of preparing a molten metal containing Fe;

an atomizing step of forming a Fe powder or a Fe-containing alloy powder by dripping the molten metal while spraying water thereon to pulverize and coagulate the molten metal, thereby providing a slurry containing the Fe powder or the alloy powder and water;

a solid-liquid separation step of separating the slurry into solid and liquid, and collecting the Fe powder or the alloy powder; and

a drying step of drying the Fe powder or the alloy powder obtained in the solid-liquid separation step at 80° C. or less.

A tenth aspect of the present invention is the method for producing the Fe powder or the Fe-containing alloy powder of the ninth aspect,

wherein, in the drying step, drying is performed at 60° C. or less.

An eleventh aspect of the present invention is the method for producing the Fe powder or the Fe-containing alloy powder of the ninth or tenth aspect,

wherein the drying step is performed in a reduced-pressure environment.

A twelfth aspect of the present invention is the method for producing the Fe powder or the Fe-containing alloy powder of the ninth to eleventh aspects,

wherein the drying step is performed in a vacuum environment.

A thirteenth aspect of the present invention is the method for producing the Fe powder or the Fe-containing alloy powder of the ninth to twelfth aspects,

wherein pH of water used in the atomizing step is 9 to 13.

A fourteenth aspect of the present invention is the method for producing the Fe powder or the Fe-containing alloy powder of the ninth to twelfth aspects,

wherein pH of water used in the atomizing step is 11 to 13.

A fifteenth aspect of the present invention is the method for producing the Fe powder or the Fe-containing alloy powder of the ninth to fourteenth aspects,

wherein the electric potential of water used in the atomizing step is from −0.4 V to 0.4 V.

A sixteenth aspect of the present invention is the method for producing the Fe powder or the Fe-containing alloy powder of the ninth to fifteenth aspects,

wherein the molten metal contains Fe and 0.1 mass % to 15 mass % of Si.

A seventeenth aspect of the present invention is the method for producing the Fe-containing alloy powder of the sixteenth aspect,

wherein the molten metal contains 84 mass % to 99.7 mass % of Fe.

According to an eighteenth aspect of the present invention,

there is provided the soft magnetic material including the soft magnetic powder of any one of the first to eighth aspects and a binder.

According to a nineteenth aspect of the present invention,

there is provided a method for producing a powder magnetic core,

wherein the soft magnetic material of the eighteenth aspect is molded into a predetermined shape, and the resulting molded product is heated to obtain the powder magnetic core.

### Advantageous Effect of the Invention

According to the present invention, there is provided a soft magnetic powder which has a decreased amount of oxygen even when the particle size is decreased and can form a powder magnetic core having a high magnetic permeability, and a related technology thereof.

### BRIEF DESCRIPTION OF DRAWINGS

FIG. 1 is a diagram showing the relationship between D50×[O] and the relative magnetic permeability at a measured frequency of 10 MHz for the alloy powders produced in Examples 1 to 8 and Comparative Examples 1 to 6.

FIG. 2 is a diagram showing the relationship between D50×[O] and the relative magnetic permeability at a measured frequency of 100 MHz for the alloy powders produced in Examples 1 to 8 and Comparative Examples 1 to 6.

### DETAILED DESCRIPTION OF THE INVENTION

A soft magnetic powder, a method for producing Fe powder or a Fe-containing alloy powder, a soft magnetic material, and a method for producing a powder magnetic core according to an embodiment of the present invention will be hereinafter described.

### <Soft Magnetic Powder>

The soft magnetic powder of this embodiment includes a Fe (iron) alloy containing Si (silicon).

The soft magnetic powder includes Si in a range of 0.1 mass % to 15 mass %, and preferably includes Fe as a main component. Fe is an element that contributes to the magnetic properties and the mechanical properties of a soft magnetic powder. Si is an element that increases the magnetic permeability of a soft magnetic powder. The Si content is to be in the above range from the viewpoint of improving the magnetic permeability without impairing the magnetic properties and the mechanical properties of Fe, and is preferably 0.2 mass % to 7 mass %. Particularly, from the viewpoint of obtaining a higher magnetic permeability, the Si content is preferably from 2.0 mass % to 3.5 mass %. From the viewpoint of obtaining a higher saturation magnetization while obtaining a desired magnetic permeability, the Si content is preferably from 0.2 mass % to 0.5 mass %. The Si content may be appropriately changed according to the properties required for the soft magnetic powder. The above-mentioned main component means the one having the highest content among the elements included in the soft magnetic powder. The amount of Fe in the soft magnetic powder of this embodiment is preferably from 84 mass % to 99.7 mass %, more preferably from 92 mass % to 99.6 mass %, from the viewpoint of the magnetic properties and the mechanical properties. Further, the total amount of Fe and Si in the soft magnetic powder is preferably 98 mass % or more from the viewpoint of suppressing the deterioration of the magnetic properties due to the inclusion of impurities.

In the soft magnetic powder of this embodiment, the oxidation during the production process is suppressed, and the oxygen content is small even when the particle size becomes small. Specifically, in the soft magnetic powder of this embodiment, when the volume-based cumulative 50% particle size [m] measured by a laser diffraction particle size distribution analyzer is represented as D50 and the oxygen content [mass %] is represented as [O], their product (D50×[O]) is 3.0 [μm·mass %] or less.

Now, the product (D50 x [O]) will be described.

In the soft magnetic powder, when its volume is represented as V [m³], the surface area is represented as S [m²], and the oxygen content is represented as [O] [mass %], the following relational expression (1) is established with D50. In the relational expression (1), a parenthesized term indicates a dimension of each value. As a prerequisite, the shape of the soft magnetic powder is spherical, and D50 is regarded as a primary particle size. It should be noted that the tendency of the relational expression (1) is approximately satisfied even out of the prerequisite.

$$\begin{matrix} [ Expression 1 ] & \\ D 50 ( m ) ∝ \frac{V ( m 3 )}{S ( m 2 )} ∴ [ O ] ( wt \% ) \times D 50 ( m ) ∝ \frac{[ O ] ( wt \% ) \times V ( m 3 )}{S ( m 2 )} & ( 1 )\end{matrix}$$

When the weight of oxygen contained in the particle is represented as Wₒ [g], the weight of the particle is represented as W [g], and the density of the particle is represented as ρ[g/cm³], the following relational expression (2) is established. In the relational expression (2), a parenthesized term indicates a dimension of each value.

$$\begin{matrix} [ Expression 2 ] & \\ Wo ( g ) = W ( g ) \times [ O ] ( wt \% ) = V ( m 3 ) \times ρ ( g / cm 3 ) \times [ O ] ( wt \% ) ∴ \frac{Wo ( g )}{S ( m 2 )} = \frac{V ( m 3 ) \times ρ ( g / cm 3 ) \times [ O ] ( wt \% )}{S ( m 2 )} & ( 2 )\end{matrix}$$

In the relational expression (2), the density p of the particle varies depending on its [O], but the variation in the [O] is so small to be negligible with respect to the amount of the whole particles. Therefore, ρ is regarded as a constant. Thus, the following relational expression (3) is derived from the relational expressions (1) and (2). In the relational expression (3), a parenthesized term indicates a dimension of each value.

$$\begin{matrix} [ Expression 3 ] & \\ \frac{Wo ( g )}{S ( m 2 )} = \frac{V ( m 3 ) \times ρ ( \frac{g}{cm 3} ) \times [ O ] ( wt \% )}{S ( m 2 )} ∝ \frac{V ( m 3 ) \times [ O ] ( wt \% )}{S ( m 2 )} ∝ [ O ] ( wt \% ) \times D 50 ( m ) & ( 3 )\end{matrix}$$

Since the oxidation of the soft magnetic powder mainly occurs on the particle surface, most of oxygen contained in the particles is presumed to be present on the surface (particularly, in this embodiment, since the diffusion of oxygen due to the drying step is suppressed, most of oxygen is even more presumed to be present on the particle surface). In the relational expression (3), Wₒ/S is obtained by dividing the oxygen weight Wₒ in the particle by the surface area S of the particle, and approximately indicates the weight of oxygen (adhered to the surface) per unit area of the particle surface. Therefore, the smaller the D50×[O] which is proportional to Wₒ/S, the smaller the amount of oxygen per unit surface area of the soft magnetic powder. According to the investigation by the present inventors, the soft magnetic powder of this embodiment has a D50×[O] of 3.0 [μm·mass %] or less, and (since the oxidation in the production step of the powder is suppressed) it shows a higher magnetic permeability on the higher frequency side even when the particle size is small. In view of the foregoing, the D50×[O] is preferably from 0.5 [μm·mass %] to 2.6 [μm·mass %], and more preferably from 0.5 [μm·mass %] to 1.9 [μm·mass %].

The D50 of the soft magnetic powder of this embodiment is not particularly limited, but is preferably small from the viewpoint of reducing the eddy current loss. Specifically, it is preferably from 0.5 μm to 10 μm, more preferably from 1 μm to 5 μm.

The oxygen content [O] in the soft magnetic powder of this embodiment is preferably 0.75 mass % or less from the viewpoint of magnetic permeability ([O] is usually 0.05 mass % or more). From a similar viewpoint, the [O] is 0.10 mass % to 0.60 mass %.

The soft magnetic powder in this embodiment contains, in addition to Fe, Si, and O, a small amount of unavoidable impurities due to the influence of the raw materials and the devices and substances used in the production steps. Examples of such impurities include Na (sodium), K (potassium), Ca (calcium), Pd (palladium), Mg (magnesium), Cr (chromium), Co (cobalt), Mo (molybdenum), Zr (zirconium), C (carbon), N (nitrogen), P (phosphorus), Cl (chlorine), Mn (manganese), Ni (nickel), Cu (copper), S (sulfur), As (arsenic), B (boron), Sn (tin), Ti (titanium), V (vanadium), and Al (aluminum). It should be noted that the unavoidable impurities include additional trace elements contained in the soft magnetic powder at a level of about 1,000 ppm or less, preferably 100 ppm to 800 ppm in order to achieve a given purpose. In view of the foregoing, an aspect of the soft magnetic powder of this embodiment includes Si, O, the reminder Fe, and unavoidable impurities.

In addition, the shape of the soft magnetic powder of this embodiment is not particularly limited, and may be spherical or substantially spherical, and may be granular, laminar (flake-like), or distorted (irregular).

The carbon content [C] of the soft magnetic powder of this embodiment is preferably from 0.01 mass % to 0.30 mass %, more preferably from 0.01 mass % to 0.05 mass %, from the viewpoint of suppressing adverse effects on the magnetic properties.

The specific surface area measured by the BET one-point method (BET specific surface area) of the soft magnetic powder of this embodiment is preferably 0.15 m²/g to 3.00 m²/g, more preferably 0.20 m²/g to 2.50 m²/g, from the viewpoint of suppressing the generation of oxides on the powder surface and developing the good magnetic permeability.

A tap density of the soft magnetic powder of this embodiment is preferably from 2.5 to 7.5 g/cm³, more preferably from 3.0 to 6.5 g/cm³, from the viewpoint of increasing the packing density of the powder and developing the good magnetic permeability.

### <Method for Producing Fe Powder or Fe-Containing Alloy Powder>

Next, a method for producing the above-described soft magnetic powder will be described. This method is widely applicable to the production of a metal powder containing easily oxidizable Fe (Fe powder or a Fe-containing alloy powder). The method for producing the Fe powder or the Fe-containing alloy powder of this embodiment is an improvement of the conventional water atomization-based production method and includes a molten metal preparation step, an atomizing step, a solid-liquid separation step, and a drying step. Each step will be hereinafter described in detail.

### (Molten Metal Preparation Step)

First, a molten metal containing Fe is prepared. Specifically, for example, a Fe raw material such as electrolytic iron or pure iron, or the Fe raw material along with other metal raw materials (including Si raw materials such as silicon metal), as needed, are melted in a furnace to prepare the molten metal. The heating temperature (temperature of the molten metal) in this case is, for example, 1,536° C. to 2,000° C., and preferably 1,600° C. to 1,900° C.

The molten metal is not particularly limited as long as it contains Fe. In this embodiment, even when Fe that is easily oxidizable is used, a metal powder having a low oxygen content can be obtained. Therefore, the Fe content in the molten metal (amount of Fe charged for preparation of the molten metal) is preferably set to 14 mass % to 99.7 mass %, more preferably 49 mass % to 99.7 mass %, still more preferably 84 mass % to 99.7 mass %, and particularly preferably 84 mass % to 99.6 mass %.

Other elements to be charged together with Fe for preparation of the molten metal are not particularly limited and examples include Si, Cr, Ni, B, C, Mo, Co, and Cu. Among these, in the case where a soft magnetic powder is produced, Si, Cr, Ni, B, and C are preferable as other elements, and Si is particularly preferable because a soft magnetic powder having a lower coercive force can be obtained. The contents of other elements in the molten metal (the amount of other elements charged when the molten metal is prepared) are preferably from 0.1 mass % to 85 mass %, more preferably from 0.1 mass % to 50 mass %, more preferably from 0.1 mass % to 15 mass %, and particularly preferably from 0.3 mass % to 15 mass %. In particular, when the other metal is Si, the content in the molten metal is preferably from 0.1 mass % to 15 mass %, and more preferably from 0.2 mass % to 7 mass %.

Further, a trace element such as P may be added to the molten metal such that the content in the Fe powder or the Fe-containing powder is 100 ppm to 800 ppm (0.01 mass % to 0.08 mass %). By adding P, the soft magnetic powder to be produced can be more spherical. Namely, the tap density is improved to enable high-density filling. Therefore, when molded into a powder magnetic core, the magnetic permeability can be improved.

In the molten metal preparation step, from the viewpoint of suppressing the incorporation of oxygen into the molten metal, the molten metal is preferably prepared in a non-oxidizing gas (inert gas such as He, Ar or N₂, or reducing gas such as H₂ or CO) atmosphere. Further, various trace elements may be added to the molten metal for a predetermined purpose. Moreover, they may be added to the molten metal as an alloy with Fe.

### (Atomizing Step)

Subsequently, water as a coolant is sprayed on the molten metal prepared in the molten metal preparation step. For example, the molten metal is tapped from a nozzle having a predetermined diameter provided at the bottom of the furnace, and water is sprayed on the molten metal flow generated by tapping. Thereby, the water collides with the molten metal, and the molten metal is pulverized and cooled/coagulated to form a powder, thus providing a slurry in which the Fe powder or the Fe-containing alloy powder is dispersed in the water (which has been sprayed on the molten metal flow).

In the atomizing step, it is preferable to spray water on the alloy molten metal in a non-oxidizing gas atmosphere from the viewpoint of suppressing the oxidation of the molten metal. Examples of the non-oxidizing gas atmosphere include an inert gas such as He, Ar and N₂, and a reducing gas such as H₂ and CO.

Further, pH of the water to be sprayed on the molten metal is not particularly limited, but the pH is preferably 9 to 13 and particularly preferably from 11 to 13, in order to obtain a Fe powder or a Fe-containing metal powder with a decreased oxygen content. Further, the potential of water is preferably −0.4 V to 0.4 V, particularly preferably −0.3 V to 0.4 V, as a standard electrode potential. These points will be described in more detail in the description of the drying step. In order to adjust pH of water within the above range, various alkaline substances may be added to water, and examples thereof include sodium hydroxide, ammonia, sodium phosphate, calcium hydroxide, and hydrazine. The electric potential of water, pH of which has been adjusted in such a manner, is roughly within the above range.

The pressure (water pressure) for spraying water in the atomizing step is not particularly limited, but may be, for example, 90 MPa to 180 MPa. When the water pressure is increased, a Fe powder or a Fe-containing alloy powder, having a small particle size, can be produced.

### (Solid-Liquid Separation Step)

Subsequently, the slurry obtained in the atomizing step is subjected to solid-liquid separation to collect the Fe powder or Fe-containing alloy powder. The collected metal powder may be washed. A conventionally known solid-liquid separation method can be employed without any particular limitation. For example, the slurry may be subjected to pressure filtration using a filter press or the like.

### (Drying Step)

Subsequently, the metal powder obtained in the solid-liquid separation step is dried. Conventionally, drying at a high temperature (and under vacuum) has been performed for quick drying, but in this embodiment, the drying temperature is set to 80° C. or less to suppress the oxygen content in the metal powder to low. From the viewpoint of further reducing the oxygen content, the drying temperature is preferably set to 60° C. or less. On the other hand, from the viewpoint of decreasing the amount of time until the metal powder is dried, the drying temperature is preferably room temperature (25° C.) or more, and more preferably 30° C. or more.

In the drying step in this embodiment, the drying is performed at a lower temperature compared with the conventional one, as described above. Therefore, from the viewpoint of improving the drying speed, the drying is performed preferably in a reduced pressure environment of −0.05 MPa or less from an air pressure, more preferably in a vacuum environment (−0.095 MPa or less), rather than at an atmospheric pressure.

Performing the drying step in a lower temperature environment compared with the conventional one, as in this embodiment, is considered to avoid thermal diffusion of oxygen on the surface of the metal powder toward inside in the drying step which results in decrease of the surface oxide film functioning as a protective film against the oxidation on the particle surface, and thereby dispenses with the subsequent slow oxidation step. Further, as noted in the description of the atomizing step, by setting pH of water used in this step within an alkaline region, the oxygen content of the obtained metal powder can be decreased. In particular, by setting pH within a strongly alkaline region from 11 to 13, the oxygen content in the metal powder is found to be particularly preferably decreased. The reason is supposed as follows: in the electric potential-pH diagram of iron (which greatly affects the magnetic properties), iron forms passivity across a wide pH range, and an oxidized film on the particle surface of the metal powder which is formed by such passivity formation in the strongly alkaline region may function as a particularly preferable protective film against the oxidation.

By performing the steps described above, the Fe powder or Fe-containing alloy powder having a decreased oxygen content can be produced.

The produced Fe powder or Fe-containing alloy powder may be crushed or subjected to classification such as sieving, air classification or the like to control the particle size (particle size distribution). For example, the classification may be performed so that D50 of the Fe powder or Fe-containing alloy powder is 0.5 μm to 10 μm. Further, the powder may be subjected to a flattening processing to change the particle shape of the powder (into a flake shape or the like).

### <Soft Magnetic Material>

The above-described soft magnetic powder of this embodiment has a low coercive force and a high magnetic permeability. Particularly, since the oxygen content can be decreased even when the particle size is small, this powder has an excellent magnetic permeability even in a high frequency region. Specifically, the coercive force (Hc) measured under the conditions in Examples described later is preferably 5 to 25 Oe. Regarding the magnetic permeability, the relative magnetic permeability (μ′) measured at a measurement frequency of 10 MHz under the conditions of measurement 1 of the magnetic properties in Examples described later is preferably 8.90 or more, more preferably 9.00 to 14.00; and the relative magnetic permeability (μ′) at a measurement frequency of 100 MHz is preferably 8.90 or more, and more preferably from 9.00 to 14.00. The relative magnetic permeability (μ′) measured at a measurement frequency of 10 MHz under the conditions of measurement 2 of the magnetic properties in Examples described later is preferably 17.00 or more, more preferably from 21.00 to 30.00; and the relative magnetic permeability (μ′) at a measurement frequency of 100 MHz is preferably 17.00 or more, and more preferably from 19.50 to 28.50.

Owing to such properties, the soft magnetic powder of this embodiment can be suitably applied to a soft magnetic material. For example, a granular composite powder (soft magnetic material) can be obtained by mixing the soft magnetic powder with a binder (insulation resin and/or inorganic binder) followed by granulation. The content of the soft magnetic powder in the soft magnetic material is preferably from 80 mass % to 99.9 mass % from the viewpoint of achieving a good magnetic permeability. From a similar viewpoint, the content of the binder in the soft magnetic material is preferably 0.1 mass % to 20 mass %.

Specific examples of the insulating resin include a (meth) acrylic resin, a silicone resin, an epoxy resin, a phenol resin, a urea resin, and a melamine resin. Specific examples of the inorganic binder include a silica binder and an alumina binder. Further, the soft magnetic material may contain other components such as a wax and a lubricant, if necessary.

### <Powder Magnetic Core>

The soft magnetic material of this embodiment can be molded into a predetermined shape and heated to produce a powder magnetic core.

More specifically, the soft magnetic material of this embodiment is placed in a mold having a predetermined shape, pressurized and heated to obtain a powder magnetic core. As described above, since the powder magnetic core is excellent in magnetic permeability even in a high frequency region, a magnetic component having the powder magnetic core can be attached to an electronic device such as an inductor that operates in a high frequency region.

<Effects According to this Embodiment>

According to this embodiment, one or more of the following effects can be obtained.

In this embodiment, the slurry obtained by the atomizing step is subjected to solid-liquid separation, and the collected Fe powder or Fe-containing alloy powder is dried at a drying temperature of 80° C. or less. Preferably, the drying temperature is from 30° C. to 60° C. Thereby, the oxygen content in the finally obtained metal powder can be decreased. This is presumably because thermal diffusion of oxygen in the metal powder while drying the metal powder is suppressed to maintain the oxygen content on the particle surface to some extent, thereby oxygen intake by the additional oxidation can be decreased.

In addition, by setting the drying temperature to 80° C. or less, the conventionally required slow oxidation can be dispensed with. The reason is supposed as follows. As described above, thermal diffusion of oxygen during the drying can be suppressed, and the oxygen content in the particle surface can be maintained within a certain range, so that the sufficient oxidation resistance can be ensured.

In the drying step, the metal powder is preferably dried in a reduced-pressure environment, and more preferably in a vacuum environment. Thereby, the drying speed can be enhanced without heating the metal powder. As a result, the production efficiency can be enhanced.

The soft magnetic powder of this embodiment contains 0.1 to 15 mass % of Si, and has D50×[O] of 3.0 [μm·mass %] or less. Therefore, this soft magnetic powder is configured to have a low oxygen content per unit area on the particle surface even when the particle size D50 is decreased as small as 0.5 μm to 10 μm, for example. According to such a soft magnetic powder, even when the particle size of the soft magnetic powder is decreased in order to reduce the eddy current loss of the powder magnetic core, the increase in the amount of oxygen is suppressed to prevent the decrease in the magnetic permeability, thereby the core loss can be kept low. In addition, a high magnetic permeability can be obtained particularly on the higher frequency side. Specifically, the relative magnetic permeability μ′ at 10 MHz can be 8.90 or more and the relative magnetic permeability μ′ at 100 MHz can be 8.90 or more, as measured by a measurement method 1 of the magnetic properties in Examples described later.

The soft magnetic powder has different properties depending on the Si content. The magnetic permeability can be further improved by setting the Si content to 2.0 mass % to 3.5 mass % (at this time, the amount of Fe in the soft magnetic powder is preferably 96.0 mass % or more). Specifically, the relative magnetic permeability μ′ at 10 MHz can be 21.00 to 30.00, and the relative magnetic permeability μ′ at 100 MHz can be 21.00 to 28.50, as measured by a measurement method 2 of the magnetic properties in Examples described later. On the other hand, by setting Si to 0.2 mass % to 0.5 mass % (at this time, the amount of Fe in the soft magnetic powder is preferably 99.2 mass % or more) to increase a proportion of Fe contained in the soft magnetic powder, a higher saturation magnetization can be obtained while obtaining a desired magnetic permeability. Specifically, the saturation magnetization (generally less than 218 emu/g) can be at the value of 205 emu/g or more, while the relative magnetic permeability μ′ at 10 MHz is maintained at 17.00 to 26.00 and the relative magnetic permeability μ′ at 100 MHz is maintained at 17.00 to 26.00, as measured by the measurement method 2 of the magnetic properties in Examples described later.

### EXAMPLE

The present invention will be hereinafter described in more detail with reference to Examples, but the present invention is not limited thereby.

### Comparative Example 1

In a tundish furnace, 14 kg of electrolytic iron (purity: 99.95 mass % or more) and 1.01 kg of silicon metal (purity: 99 mass % or more) were heated to 1700° C. in a nitrogen atmosphere to melt, obtaining a molten metal. While dripping the molten metal from the bottom of the tundish furnace under a nitrogen atmosphere (oxygen concentration 300 ppm or less), high-pressure water (pH 10.3, electric potential 284 mV) was sprayed at a water pressure of 150 MPa and a water amount of 160L/min to rapidly cool and solidify the molten metal. The resulting slurry was separated into solid and liquid, and the solid was washed with water, and dried at 120° C. for 10 hours under a nitrogen atmosphere. The standard substance at the time of pH measurement of high-pressure water is as follows:
pH 4.01 (25° C.): Phthalate pH standard solution;
pH 6.86 (25° C.): Neutral phosphate pH standard solution;
pH 9.18 (25° C.): Borate pH standard solution.

After that, the dried solid was placed in a drier, a nitrogen atmosphere was created in the drier over 1 hour, and the temperature was increased to 40° C. and held at that temperature. After that, oxygen was supplied to the drier still at 40° C. to provide stepwise increase of the oxygen concentration from 1 mass % to 21 mass %, with the respective oxygen concentration being held for a predetermined period of time to perform the slow oxidation. In this slow oxidation, the oxygen concentration was held at 1 mass % for 30 minutes, at 2 mass % for 45 minutes, at 4 mass % for 100 minutes, at 5 mass % for 60 minutes, at 8 mass % for 60 minutes, at 16 mass % for 30 minutes, and at 21 mass % for 5 minutes. The resulting dry powder was crushed and subjected to air classification to obtain an alloy powder according to Comparative Example 1.

The BET specific surface area, tap density, oxygen content, carbon content, particle size distribution, composition, and magnetic properties of thus obtained alloy powder were determined. The results are enumerated in Tables 2 and 3 shown below.

BET specific surface area was measured with a BET specific surface area measuring device (4-sorb US, manufactured by Yuasa Ionics Co., Ltd.) by degassing by flowing nitrogen gas at 105° C. for 20 minutes in the measuring device. Measurement was performed by a BET one-point method while flowing a mixed gas of nitrogen and helium (N₂: 30 vol %, He: 70 vol %).

As for the tap density (TAP), in the same manner as described in Japanese Unexamined Patent Publication No. 2007-263860, a bottomed cylindrical die having an inner diameter of 6 mm and a height of 11.9 mm was filled up to 80% of its volume with an alloy powder to form an alloy powder layer, a pressure of 0.160 N/m² was uniformly applied to a top surface of the alloy powder layer, and the alloy powder layer was compressed at that pressure until the alloy powder was no more densely packed. After that, a height of the alloy powder layer was measured, and a density of the alloy powder was obtained from the measured height of the alloy powder layer and a weight of the filled alloy powder. The obtained density was defined as a tap density of the alloy powder.

The oxygen content was measured by an oxygen/nitrogen/hydrogen analyzer (EMGA-920, manufactured by Horiba, Ltd.).

The carbon content was measured using a carbon/sulfur analyzer (EMIA-220V, manufactured by Horiba, Ltd.).

The particle size distribution was measured at a dispersive pressure of 5 bar by a laser diffraction particle size distribution analyzer (HELOS & RODOS (air flow type drying module) manufactured by Sympatec GmbH).

The composition of the alloy powder was analyzed for Fe, Si, and P.

Specifically, Fe was analyzed by a titrimetric method according to JIS M8263 (Chromium ores—Determination of total iron content) as follows. First, sulfuric acid and hydrochloric acid were added to 0.1 g of a sample (alloy powder) for thermolysis, and heated until white smoke of sulfuric acid was generated. After cooling, water and hydrochloric acid were added and warmed to dissolve the soluble salts. Then, after warm water was added to the obtained sample solution to adjust the liquid volume to about 120 to 130mL and the liquid temperature was adjusted to about 90 to 95° C., several drops of an indigo carmine solution were added, and a titanium (III) chloride solution was added to the sample solution until the color of the sample solution turned from yellow-green to blue and then colorless and transparent. Subsequently, a potassium dichromate solution was added until the sample solution retained the blue-color state for 5 seconds. Iron (II) in this sample solution was titrated with a potassium dichromate standard solution using an automatic titrator to determine the amount of Fe.

Si was analyzed by a gravimetric method as follows. First, hydrochloric acid and perchloric acid were added to a sample (alloy powder) for thermolysis, and heated until white smoke of perchloric acid was generated. Heating was continued to dryness. After cooling, water and hydrochloric acid were added and warmed to dissolve the soluble salts. Subsequently, the insoluble residue was filtered using a filter paper, and the residue was transferred to a crucible together with the filter paper, and dried and incinerated. After cooling, the total weight of the crucible was weighed. A small amount of sulfuric acid and hydrofluoric acid were added, heated to dryness, and then intensely heated. After cooling, the total weight of the crucible was weighed. Then, the second measured weight was subtracted from the first measured weight, and considering the weight difference as SiO₂, the Si amount was calculated.

P was analyzed by an inductively coupled plasma (ICP) emission spectrometer (SPS3520V, manufactured by Hitachi High-Tech Science Corporation).

### [Measurement of Magnetic Properties (Magnetic Permeability, Magnetic Loss, Saturation Magnetization and Coercive Force)] (Measurement of Magnetic Properties 1)

An alloy powder and a bisphenol F type epoxy resin (manufactured by TESK CO., LTD.; one-part epoxy resin B-1106) were weighed at a mass ratio of 90 : 10, and kneaded using a vacuum mixing/degassing mixer (manufactured by EME; V-mini 300) to obtain a paste of a test powder dispersed in the epoxy resin. The paste was dried on a hot plate at 60° C. for 2 hours to form a composite of the alloy powder and the resin, and then pulverized into a powder to obtain a composite powder. In a donut-shaped container, 0.2 g of this composite powder was placed and a 9800 N (1 Ton) load was applied by a hand press machine to obtain a toroidal-shaped molded article having an outer diameter of 7 mm and an inner diameter of 3 mm. For the molded article, a real part μ′ and an imaginary part μ″ of a complex relative magnetic permeability were measured at 10 MHz and 100 MHz using a RF impedance/material analyzer (manufactured by Agilent Technologies; E4991A) and a test fixture (manufactured by Agilent Technologies; 16454A), to determine a loss coefficient tan δ=μ″/μ′ of the complex relative magnetic permeability.

In addition, the magnetic properties of the alloy powder were measured using a high-sensitivity vibration sample magnetometer (manufactured by Toei Industry Co., Ltd.; VSM-P7-15), with an applied magnetic field (10 kOe), in a M measurement range (50 emu), at a step bit of 100 bit, with a time constant of 0.03 sec, and with a wait time of 0.lsec. Using a BH curve, the saturation magnetization σs and the coercive force Hc were determined. The processing constant was determined following the manufacturer's instruction. Specifically, it was as follows.

Intersection detection: Least squares method; M average score, 0; H average score, 0

Ms Width, 8; Mr Width, 8; Hc Width, 8; SFD Width, 8; S. Star Width, 8

Sampling time (sec): 90

Two-point correction P1 (Oe): 1000

Two-point correction P2 (Oe): 4500

### Comparative Examples 2 to 6 and Examples 1 to 8

The alloy powders of Comparative Examples 2 to 6 were produced in the same manner as in Comparative Example 1, except that the atmosphere during the water atomization, pH and the electric potential of high-pressure water used for the water atomization, and the temperature during the slow oxidation were changed as shown in Table 1 below. In Comparative Example 2, the air classification conditions were changed. In addition, the alloy powders of Examples 1 to 8 were prepared in the same manner as in Comparative Example 1, except that pH and the electric potential of high-pressure water used for the water atomization, the charged amount of the molten metal raw material, and the drying conditions (atmosphere, temperature and time) of the water-washed solid were changed as shown in Table 1 below (vacuum atmosphere is −0.095 MPa or less from an air pressure) and further slow oxidation was not performed. In Example 4, the air classification conditions were changed, and in Examples 5 to 8, pure iron (purity: 99 mass % or more) was used as the iron raw material. In the column of the slow oxidation temperature in Table 1, “none” is indicated for Examples 1 to 8. Further, P used in Examples 6 and 7 was charged into a tundish furnace as a FeP alloy (so that the added amount as P is as shown in Table 1).

TABLE 1

| | Atomization | | | | | | | | | |
|---|---|---|---|---|---|---|---|---|---|---|
| | condition | | | Charged amount | | | Drying condition | | | f |
| | | b | c | Fe | Si | P | | d | e | d |
| | a | pH | mV | wt % | wt % | wt % | a | ° C. | hr. | ° C. |
| Com. | N₂ | pH 10.3 | 284 | 93.8 | 6.2 | 0 | N₂ | 120 | 10 | 40 |
| Ex. 1 | | | | | | | | | | |
| Com. | N₂ | pH 10.3 | 284 | 93.8 | 6.2 | 0 | N₂ | 120 | 10 | 40 |
| Ex. 2 | | | | | | | | | | |
| Com. | Air | pH 5.8 | 381 | 93.8 | 6.2 | 0 | N₂ | 120 | 10 | 60 |
| Ex. 3 | | | | | | | | | | |
| Com. | Air | pH 10.3 | 284 | 93.8 | 6.2 | 0 | N₂ | 120 | 10 | 60 |
| Ex. 4 | | | | | | | | | | |
| Com. | N₂ | pH 10.3 | 284 | 93.8 | 6.2 | 0 | N₂ | 120 | 10 | 60 |
| Ex. 5 | | | | | | | | | | |
| Com. | N₂ | pH 5.8 | 381 | 93.8 | 6.2 | 0 | N₂ | 120 | 10 | 40 |
| Ex. 6 | | | | | | | | | | |
| Ex. 1 | N₂ | pH 10.3 | 284 | 93.8 | 6.2 | 0 | Vacuum | 40 | 10 | None |
| Ex. 2 | N₂ | pH 12 | 107 | 93.8 | 6.2 | 0 | Vacuum | 40 | 30 | None |
| Ex. 3 | N₂ | pH 12 | 107 | 93.8 | 6.2 | 0 | Vacuum | 40 | 30 | None |
| Ex. 4 | N₂ | pH 12 | 107 | 93.8 | 6.2 | 0 | Vacuum | 40 | 30 | None |
| Ex. 5 | N₂ | pH 12 | 107 | 93.8 | 6.2 | 0 | Vacuum | 40 | 30 | None |
| Ex. 6 | N₂ | pH 12 | 107 | 93.75 | 6.2 | 0.05 | Vacuum | 40 | 30 | None |
| Ex. 7 | N₂ | pH 12 | 107 | 93.75 | 6.2 | 0.05 | Vacuum | 40 | 10 | None |
| Ex. 8 | N₂ | pH 12 | 107 | 97 | 3.0 | 0 | Vacuum | 40 | 10 | None |

a = Atmosphere
b = pH of high-pressure water
c = Electric potential of high-pressure water
d = Temperature
e = Time
f = Slow oxidation
Ex. = Example
Com.Ex. = Comparative Example

For the alloy powders of Comparative Examples 2 to 6 and Examples 1 to 8, the BET specific surface area, tap density, oxygen content, carbon content, particle size distribution, and composition were determined as in Comparative Example 1. The results are shown in Table 2 below, together with the results of Comparative Example 1.

TABLE 2

| | Composition | | | | Tap | Oxygen | Carbon | | | | | | |
|---|---|---|---|---|---|---|---|---|---|---|---|---|---|
| | Fe | Si | P | a | density | content | content | Particle size distribution (μm) | | | | | |
| | wt % | wt % | wt % | (m²/g) | (g/cm²) | wt % | wt % | D10 | D25 | D50 | D75 | D90 | D99 |
| Com.Ex. 1 | 92.8 | 6.2 | 0 | 2.25 | 3.5 | 1.26 | 0.032 | 1.3 | 2.0 | 2.9 | 4.0 | 5.3 | 9.8 |
| Com.Ex. 2 | 92.5 | 6.4 | 0 | 1.36 | 3.8 | 0.82 | 0.028 | 1.8 | 2.9 | 4.6 | 7.3 | 10.6 | 19.5 |
| Com.Ex. 3 | 92.2 | 6.6 | 0 | 3.00 | 3.3 | 1.79 | 0.030 | 1.3 | 2.0 | 2.9 | 4.0 | 5.3 | 8.5 |
| Com.Ex. 4 | 92.1 | 6.4 | 0 | 2.45 | 3.5 | 1.45 | 0.028 | 1.4 | 2.1 | 3.0 | 4.1 | 5.4 | 9.0 |
| Com.Ex. 5 | 92.6 | 6.4 | 0 | 1.49 | 3.5 | 1.23 | 0.043 | 1.5 | 2.2 | 3.1 | 4.3 | 5.6 | 8.5 |
| Com.Ex. 6 | 92 | 6.5 | 0 | 2.63 | 3.4 | 1.36 | 0.037 | 1.3 | 2.9 | 2.9 | 3.9 | 5.2 | 9.8 |
| Ex. 1 | 92.5 | 6.5 | 0 | 1.30 | 3.5 | 0.70 | 0.034 | 1.4 | 2.1 | 3.0 | 4.2 | 5.5 | 9.9 |
| Ex. 2 | 92.9 | 6.4 | 0 | 0.79 | 3.6 | 0.47 | 0.033 | 1.4 | 2.1 | 3.1 | 4.3 | 5.8 | 10.4 |
| Ex. 3 | 93.8 | 6.4 | 0 | 0.71 | 3.6 | 0.45 | 0.035 | 1.2 | 1.9 | 2.8 | 3.9 | 5.2 | 8.8 |
| Ex. 4 | 93.8 | 6.4 | 0 | 0.51 | 3.7 | 0.30 | 0.028 | 1.7 | 2.8 | 4.5 | 6.9 | 9.7 | 16.5 |
| Ex. 5 | 93.4 | 6.4 | 0 | 0.68 | 3.5 | 0.41 | 0.298 | 1.3 | 2.0 | 2.9 | 3.9 | 5.2 | 10.0 |
| Ex. 6 | 93.8 | 6.4 | 0.05 | 0.65 | 3.6 | 0.38 | 0.035 | 1.4 | 2.2 | 3.2 | 4.3 | 5.7 | 9.8 |
| Ex. 7 | 94.1 | 6.4 | 0.05 | 0.61 | 3.6 | 0.43 | 0.029 | 1.4 | 2.2 | 3.2 | 4.4 | 5.8 | 11.1 |
| Ex. 8 | 96.1 | 2.8 | 0 | 0.75 | 3.3 | 0.53 | 0.028 | 1.1 | 1.6 | 2.3 | 3.2 | 4.2 | 7.9 |

a = BET specific surface area
Ex. = Example
Com.Ex. = Comparative Example

The magnetic properties of the alloy powders of Comparative Examples 2 to 6 and Examples 1 to 8 were determined in the same manner as in Comparative Example 1. The results are shown in Table 3 below.

TABLE 3

| | | | | High | | | High | | |
|---|---|---|---|---|---|---|---|---|---|
| | D50 × | | | frequency | | | frequency | | |
| | [O] | | | property | | | property | | |
| | (wt % · | Hc | σ s | (10 MHz) | | | (100 MHz) | | |
| | μm) | (Oe) | (emu/g) | μ′ | μ″ | tan δ | μ′ | μ″ | tan δ |
| Com. | 3.65 | 17 | 182 | 8.88 | 0.02 | 0.00 | 8.67 | 0.74 | 0.09 |
| Ex. 1 | | | | | | | | | |
| Com. | 3.77 | 15 | 183 | 8.79 | −0.41 | −0.05 | 8.54 | 0.94 | 0.11 |
| Ex. 2 | | | | | | | | | |
| Com. | 5.19 | 17 | 179 | 8.69 | −0.43 | −0.05 | 8.76 | 0.79 | 0.09 |
| Ex. 3 | | | | | | | | | |
| Com. | 4.35 | 17 | 181 | 8.84 | −0.28 | −0.03 | 8.78 | 0.76 | 0.09 |
| Ex. 4 | | | | | | | | | |
| Com. | 3.81 | 18 | 182 | 8.68 | −0.62 | −0.07 | 8.70 | 0.70 | 0.08 |
| Ex. 5 | | | | | | | | | |
| Com. | 3.94 | 17 | 181 | 8.03 | −0.02 | 0.00 | 7.82 | 0.67 | 0.09 |
| Ex. 6 | | | | | | | | | |
| Ex. 1 | 2.10 | 16 | 184 | 9.55 | −0.08 | −0.01 | 9.40 | 0.88 | 0.09 |
| Ex. 2 | 1.46 | 16 | 186 | 9.70 | −0.13 | −0.01 | 9.59 | 0.97 | 0.10 |
| Ex. 3 | 1.26 | 16 | 186 | 9.09 | −0.09 | −0.01 | 9.01 | 0.85 | 0.09 |
| Ex. 4 | 1.35 | 15 | 187 | 9.40 | −0.09 | −0.01 | 9.16 | 1.02 | 0.11 |
| Ex. 5 | 1.19 | 16 | 184 | 8.95 | −0.07 | −0.01 | 9.00 | 0.74 | 0.08 |
| Ex. 6 | 1.21 | 15 | 187 | 9.24 | 0.04 | 0.00 | 9.16 | 0.86 | 0.09 |
| Ex. 7 | 1.38 | 13 | 186 | 10.17 | 0.07 | 0.01 | 10.02 | 1.01 | 0.10 |
| Ex. 8 | 1.22 | 23 | 199 | 11.64 | 0.04 | 0.00 | 11.83 | 1.16 | 0.10 |

Ex. = Example
Com.Ex. = Comparative Example

In this measurement of magnetic properties, noise occurred in the measurement of the imaginary part μ″ of the complex relative magnetic permeability at a measurement frequency of 10 MHz, and some of the measurements had negative numerical values. The same applies to the measurement results of the measurement of magnetic properties 2 described later.

Comparing Comparative Example 1 with Example 1, it is seen that the oxygen content and D50×[O] of the obtained alloy powder become lower by lowering the drying temperature of the alloy powder to 40° C. (performed under vacuum to ensure a practical drying speed). As a result, the relative magnetic permeability (μ′) is increased to more than 8.90 at both the measurement frequencies 10 MHz and 100 MHz.

Also, comparing Comparative Examples 4 with Comparative Example 5, it can be seen that the oxygen content of the obtained alloy powder can be decreased by changing the atmosphere during the water atomization from the air atmosphere to the nitrogen atmosphere. Furthermore, by comparing Comparative Example 1 with Comparative Example 6 and Comparative Example 3 with Comparative Example 4, it can be seen that the oxygen content of the resulting alloy powder can be decreased by changing pH of the high-pressure water used for the water atomization from 5.8 (pure water) to 10.3 (weakly alkaline region). Examples 1 to 8 employ such preferable water atomization conditions.

Further, under the conditions of Example 1, since pH of the high-pressure water used for the water atomization is set to 12.0 which is within a strongly alkaline region, good result is obtained including the further decreased oxygen content of the resulting alloy powder and the relative magnetic permeability (μ′) of more than 8.90 at both the measurement frequencies 10 MHz and 100 MHz (Examples 2 to 8).

Further, even when P (phosphorus) is added (Examples 6 and 7) or even when the amount of Si is decreased (Example 8), a soft magnetic powder having a low oxygen content and a relative magnetic permeability (μ′) of more than 8.90 at both the measurement frequencies 10 MHz and 100 MHz can be obtained by performing the water atomization and the drying under the conditions in Examples 1 to 8.

When the amount of Si is decreased (Example 8), higher saturation magnetization can be achieved.

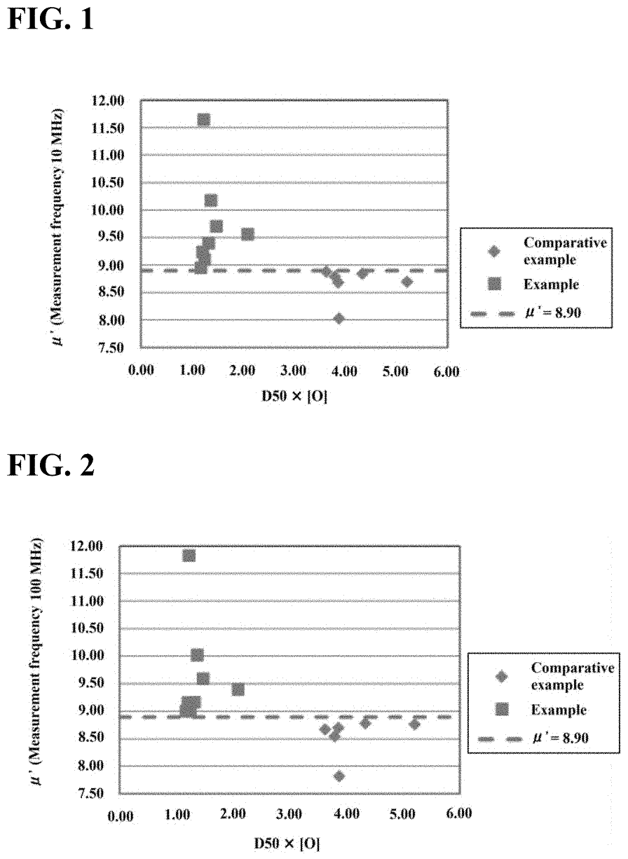

The relationship between the relative magnetic permeability (μ′) and the product of the oxygen content multiplied by D50 (D50×[O]) of the alloy powder of Examples and Comparative Examples is shown in FIG. 1 (measurement frequency: 10 MHz) and FIG. 2 (Measurement frequency: 100 MHz).

An approximately negative correlation can be seen between D50×[O] and the relative magnetic permeability. There are some cases in which the result is not such that the smaller the value of D50×[O], the higher the relative magnetic permeability is (for example, Examples 3 and 4). It is considered because the magnetic permeability becomes higher as the composite powder is more densely packed in a molded body and the degree of the filling is influenced by the particle size distribution of the alloy powder, the molded body being obtained from the composite powder containing the alloy powder by applying load thereto during the measurement of the magnetic properties. The same applies to the measurement results of the measurement of magnetic properties 2 described later.

### Examples 9 to 19

The alloy powders of Examples 9 to 19 were prepared in the same manner as in Comparative Example 1, except that the charging ratio of the molten metal raw materials, atmosphere during the water atomization, pH and the electric potential of the high-pressure water used for the water atomization, the drying conditions and the presence or absence of the slow oxidation were set as shown in Table 4 below and the conditions for the wind classification were changed. Note that P used in Examples 14 and 15 was charged into the tundish furnace as a FeP alloy (so that the added amount as P was as shown in Table 1).

TABLE 4

| | Atomization | | | | | | | | | |
|---|---|---|---|---|---|---|---|---|---|---|
| | condition | | | Charged amount | | | Drying condition | | | f |
| | | b | c | Fe | Si | P | | d | e | d |
| | a | pH | mV | wt % | wt % | wt % | a | ° C. | hr. | ° C. |
| Ex. 9 | N₂ | pH 12 | 107 | 93.80 | 6.2 | 0 | Vacuum | 40 | 30 | None |
| Ex. 10 | N₂ | pH 12 | 107 | 97.00 | 3.0 | 0 | Vacuum | 40 | 10 | None |
| Ex. 11 | N₂ | pH 12 | 107 | 99.60 | 0.4 | 0 | Vacuum | 40 | 40 | None |
| Ex. 12 | N₂ | pH 12 | 107 | 99.60 | 0.4 | 0 | Vacuum | 40 | 40 | None |
| Ex. 13 | N₂ | pH 12 | 107 | 99.60 | 0.4 | 0 | Vacuum | 40 | 40 | None |
| Ex. 14 | N₂ | pH 12 | 107 | 93.77 | 6.2 | 0.03 | Vacuum | 40 | 20 | None |
| Ex. 15 | N₂ | pH 12 | 107 | 94.67 | 5.3 | 0.03 | Vacuum | 40 | 20 | None |
| Ex. 16 | N₂ | pH 12 | 107 | 97.00 | 3.0 | 0 | Vacuum | 40 | 20 | None |
| Ex. 17 | N₂ | pH 12 | 107 | 97.00 | 3.0 | 0 | Vacuum | 40 | 20 | None |
| Ex. 18 | N₂ | pH 12 | 107 | 99.60 | 0.4 | 0 | Vacuum | 40 | 20 | None |
| Ex. 19 | N₂ | pH 12 | 107 | 99.60 | 0.4 | 0 | Vacuum | 40 | 20 | None |

a = Atmosphere
b = pH of high-pressure water
c = Electric potential of high-pressure water
d = Temperature
e = Time
f = Slow oxidation
Ex. = Example

For the alloy powders of Examples 9 to 19, the BET specific surface area, tap density, oxygen content, carbon content, particle size distribution, and composition were determined as in Comparative Example 1. The results are shown in Table 5 below.

TABLE 5

| | Composition | | | | Tap | Oxygen | Carbon | | | | | | |
|---|---|---|---|---|---|---|---|---|---|---|---|---|---|
| | Fe | Si | P | a | density | content | content | Particle size distribution (μm) | | | | | |
| | wt % | wt % | wt % | (m²/g) | (g/cm²) | wt % | wt % | D10 | D25 | D50 | D75 | D90 | D99 |
| Ex. 9 | 93.4 | 6.4 | 0 | 0.50 | 3.9 | 0.29 | 0.294 | 1.7 | 2.7 | 4.3 | 6.5 | 9.0 | 15.4 |
| Ex. 10 | 96.1 | 2.8 | 0 | 0.89 | 3.5 | 0.63 | 0.031 | 1.0 | 1.5 | 2.1 | 2.8 | 3.7 | 7.6 |
| Ex. 11 | 99.6 | 0.3 | 0 | 0.75 | 3.7 | 0.49 | 0.014 | 1.0 | 1.5 | 2.2 | 2.9 | 3.8 | 6.5 |
| Ex. 12 | 99.6 | 0.3 | 0 | 0.60 | 3.8 | 0.41 | 0.012 | 1.2 | 1.9 | 2.9 | 4.0 | 5.3 | 9.2 |
| Ex. 13 | 99.6 | 0.3 | 0 | 0.42 | 4.1 | 0.33 | 0.011 | 1.6 | 2.7 | 4.5 | 7.1 | 10.2 | 17.4 |
| Ex. 14 | 95.6 | 6.5 | 0.031 | 0.67 | 3.7 | 0.48 | 0.028 | 1.5 | 2.3 | 3.4 | 4.7 | 6.2 | 9.8 |
| Ex. 15 | 95.8 | 5.6 | 0.031 | 0.78 | 3.6 | 0.56 | 0.025 | 1.3 | 2.0 | 3.0 | 4.2 | 5.6 | 8.9 |
| Ex. 16 | 98.3 | 3.1 | 0 | 0.39 | 3.8 | 0.26 | 0.013 | 2.4 | 3.4 | 5.0 | 7.4 | 10.1 | 16.1 |
| Ex. 17 | 96.8 | 2.4 | 0 | 0.52 | 3.8 | 0.32 | 0.011 | 1.7 | 2.7 | 4.2 | 6.2 | 8.5 | 13.9 |
| Ex. 18 | 99.3 | 0.4 | 0 | 0.50 | 3.9 | 0.32 | 0.010 | 1.5 | 2.5 | 3.9 | 6.0 | 8.3 | 13.8 |
| Ex. 19 | 99.6 | 0.3 | 0 | 0.77 | 3.7 | 0.52 | 0.018 | 0.9 | 1.4 | 2.1 | 2.9 | 3.9 | 6.6 |

a = BET specific surface area
Ex. = Example

### [Measurement of Magnetic Properties (Magnetic Permeability, Magnetic Loss, Saturation Magnetization and Coercive Force)] (Measurement of Magnetic Properties 2)

For the alloy powders of Examples 9 to 19, the measurement of the magnetic properties was performed as follows. An alloy powder and a bisphenol F type epoxy resin (manufactured by TESK CO., LTD.; one-part epoxy resin B-1106) were weighed at a mass ratio of 97:3, and kneaded using a vacuum mixing/degassing mixer (manufactured by EME; V-mini 300) to obtain a paste of a test powder dispersed in the epoxy resin. The paste was dried on a shelf-type dryer at 60° C. for 2 hours to form a composite of the alloy powder and the resin, and then pulverized into a powder to obtain a composite powder. Using this composite powder, the real part and the imaginary part μ″ of the complex relative magnetic permeability at 10 MHz and 100 MHz were measured, in the same manner as in the measurement of magnetic properties 1, and the loss coefficient of the complex relative magnetic permeability tan δ32 μ″/μ′: was determined. Further, the saturation magnetization σs and the coercive force Hc of the alloy powder were determined in the same manner as in the measurement of magnetic properties 1. Again, the real part μ′ and the imaginary part μΔ of the complex relative magnetic permeability at 10 MHz and 100 MHz were measured for the alloy powder of Comparative Example 2, Examples 4 and 8, in the same manner. The above results are shown in Table 6 below.

TABLE 6

| | | | | High | | | High | | |
|---|---|---|---|---|---|---|---|---|---|
| | D50 × | | | frequency | | | frequency | | |
| | [O] | | | property | | | property | | |
| | (wt % · | Hc | σ s | (10 MHz) | | | (100 MHz) | | |
| | μm) | (Oe) | (emu/g) | μ′ | μ″ | tan δ | μ′ | μ″ | tan δ |
| Com. | 3.77 | 15 | 183 | 17.53 | 0.35 | 0.02 | 16.43 | 2.92 | 0.18 |
| Ex. | | | | | | | | | |
| 2 | | | | | | | | | |
| Ex. | 1.35 | 15 | 187 | 20.12 | 0.11 | 0.01 | 19.05 | 3.62 | 0.19 |
| 4 | | | | | | | | | |
| Ex. | 1.22 | 23 | 199 | 22.36 | 0.33 | 0.01 | 22.64 | 2.26 | 0.10 |
| 8 | | | | | | | | | |
| Ex. | 1.25 | 15 | 185 | 17.43 | −0.01 | 0.00 | 17.02 | 2.67 | 0.16 |
| 9 | | | | | | | | | |
| Ex. | 1.32 | 23 | 199 | 21.13 | 0.36 | 0.02 | 21.44 | 1.87 | 0.09 |
| 10 | | | | | | | | | |
| Ex. | 1.08 | 23 | 206 | 17.58 | 0.07 | 0.00 | 17.96 | 1.88 | 0.10 |
| 11 | | | | | | | | | |
| Ex. | 1.19 | 21 | 206 | 18.91 | −0.02 | 0.00 | 19.13 | 2.59 | 0.14 |
| 12 | | | | | | | | | |
| Ex. | 1.49 | 21 | 207 | 21.02 | 0.52 | 0.02 | 19.91 | 4.34 | 0.22 |
| 13 | | | | | | | | | |
| Ex. | 1.63 | 15 | 185 | 17.59 | −0.03 | 0.00 | 17.17 | 2.58 | 0.15 |
| 14 | | | | | | | | | |
| Ex. | 1.66 | 17 | 190 | 17.34 | 0.02 | 0.00 | 17.23 | 2.40 | 0.14 |
| 15 | | | | | | | | | |
| Ex. | 1.30 | 21 | 200 | 22.18 | 0.21 | 0.01 | 21.52 | 4.65 | 0.22 |
| 16 | | | | | | | | | |
| Ex. | 1.34 | 20 | 203 | 23.00 | 0.17 | 0.01 | 23.02 | 4.25 | 0.18 |
| 17 | | | | | | | | | |
| Ex. | 1.25 | 21 | 209 | 21.42 | 0.74 | 0.03 | 20.90 | 4.10 | 0.20 |
| 18 | | | | | | | | | |
| Ex. | 1.09 | 24 | 206 | 17.24 | 0.06 | 0.00 | 17.72 | 1.73 | 0.10 |
| 19 | | | | | | | | | |

Ex. = Example
Com.Ex. = Comparative Example

As shown in Table 6, in Examples 8, 10, 16 and 17, by setting the amount of Si to about 2.0 to 3.0 mass %, it was confirmed that the magnetic permeability can be improved as compared with that of Examples 4, 9, 14, and 15, in which the amount of Si is set to around 6.0 mass %, and that both of the relative magnetic permeability μ′ at 10 MHz and the relative magnetic permeability μ′ at 100 MHz can be 21.00 or more.

Further, in Examples 11 to 13, and 18, and 19, by further decreasing the amount of Si, compared with those in Examples 8, 10, 16, and 17, to about 0.3 mass %, it is confirmed that still higher saturation magnetization of more than 205 emu/g can be obtained compared to those in Examples 8, 10, 16, and 17, while maintaining a somewhat high magnetic permeability.

As described above, according to the present invention, by drying the soft magnetic powder at 80° C. or less, the soft magnetic powder can be configured to satisfy D50×[O]≤3.0, and the oxygen content can be decreased even when the particle size D50 is decreased. According to such a soft magnetic powder, when formed into a powder magnetic core, high magnetic permeability can be realized on the higher frequency side and the eddy current loss can be suppressed to reduce the core loss.

### INDUSTRIAL APPLICABILITY

Since the soft magnetic powder of the present invention can achieve high magnetic permeability even when a particle size is small, it can be suitably used for applications such as a powder magnetic core, an electromagnetic wave shield, an electromagnetic wave absorber, a magnetic shield, and a laminated inductor.

1. A soft magnetic powder comprising Fe alloy containing Si,
the soft magnetic powder containing 0.1 mass % to 15 mass % of Si, and
a product of D50 multiplied by [O] (D50×[O]) being 3.0 [μm·mass %] or less, wherein D50 represents a cumulative 50% particle size [μm] of the soft magnetic powder as measured by a laser diffraction particle size distribution analyzer, and [O] represents an oxygen content [mass %].

2. The soft magnetic powder according to claim 1,
wherein the D50 is 0.5 μm to 10 μm.

3. The soft magnetic powder according to claim 1,
wherein the [O] is 0.75 mass % or less.

4. The soft magnetic powder according to claim 1,
wherein a product of the D50 multiplied by the [O] (D50×[O]) is 0.5 [μm·mass %] to 2.6 [μm·mass %].

5. The soft magnetic powder according to claim 1,
comprising 84 mass % to 99.7 mass % of Fe.

6. The soft magnetic powder according to claim 1,
comprising 2.0 mass % to 3.5 mass % of Si.

7. The soft magnetic powder according to claim 1,
comprising 0.2 mass % to 0.5 mass % of Si.

8. The soft magnetic powder according to claim 1,
wherein the [O] is 0.10 mass % to 0.60 mass %.

9. A method for producing a Fe powder or a Fe-containing alloy powder, comprising:
a molten metal preparation step of preparing a molten metal containing Fe;
an atomizing step of forming a Fe powder or a Fe-containing alloy powder by dripping the molten metal while spraying water thereon to pulverize and coagulate the molten metal, thereby providing a slurry containing the Fe powder or the alloy powder and water;
a solid-liquid separation step of separating the slurry into solid and liquid, and collecting the Fe powder or the alloy powder; and
a drying step of drying the Fe powder or the alloy powder obtained in the solid-liquid separation step at 80° C. or less.

10. The method for producing the Fe powder or the Fe-containing alloy powder according to claim 9,
wherein, in the drying step, drying is performed at 60° C. or less.

11. The method for producing the Fe powder or the Fe-containing alloy powder according to claim 9,
wherein the drying step is performed in a reduced-pressure environment.

12. The method for producing the Fe powder or the Fe-containing alloy powder according to claim 9,
wherein the drying step is performed in a vacuum environment.

13. The method for producing the Fe powder or the Fe-containing alloy powder according to claim 9,
wherein pH of water used in the atomizing step is 9 to 13.

14. The method for producing the Fe powder or the Fe-containing alloy powder according to claim 9,
wherein pH of water used in the atomizing step is 11 to 13.

15. The method for producing the Fe powder or the Fe-containing alloy powder according to claim 9,
wherein the electric potential of water used in the atomizing step is from −0.4 V to 0.4 V.

16. The method for producing the Fe powder or the Fe-containing alloy powder according to claim 9,
wherein the molten metal contains Fe and 0.1 mass % to 15 mass % of Si.

17. The method for producing the Fe powder according to claim 16,
wherein the molten metal contains 84 mass % to 99.7 mass % of Fe.

18. A soft magnetic material comprising the soft magnetic powder according to claim 1 and a binder.

19. A method for producing a powder magnetic core,
wherein the soft magnetic material according to claim 18 is molded into a predetermined shape, and the resulting molded product is heated to obtain the powder magnetic core.
